(19) United States
(12) Patent Application Publication
(10) Pub. No.: US 2023/0357029 A1
(43) Pub. Date: Nov. 9, 2023

(54) WATER INDUCED CRYSTALLIZATION PROCESS TO CONVERT OLIVINE TO IDDINGSITE BY HYDRATION IN HIGHLY OXIDIZING ENVIRONMENT UNDER LOW PRESSURE AND TEMPERATURES

(71) Applicant: DISTINGUISHED FOR INTELLECTUAL PROPERTY CO., Amman (JO)

(72) Inventor: Wael Fatehi Ramadan Abu-Irmaileh, Amman (JO)

(73) Assignee: DISTINGUISHED FOR INTELLECTUAL PROPERTY CO., Amman (JO)

(21) Appl. No.: 17/912,143

(22) PCT Filed: Apr. 27, 2020
(86) PCT No.: PCT/IB2020/053932

§ 371 Date: Sep. 16, 2022

(30) Foreign Application Priority Data
Mar. 17, 2020 (JO) 62/2020

(51) Int. Cl. C01B 33/22

(52) U.S. Cl. CPC C01B 33/22; C01P 2004/02; C01P 2002/72

(57) ABSTRACT

The present invention provides a water induced crystallization process (WI-Process) to convert Olivine to Iddingsite in a highly oxidizing environment under low pressure and temperatures less than 200° C. and preferably higher than 70° C., optionally in the presence of catalysts accompanied by the process including Oleic acid, Amino acid and there derivatives such as Triethylamine either alone or in combination

### BACKGROUND OF THE INVENTION

Naturally, Iddingsite is a common alteration of Olivine during oxidation, hydrothermal and deuteric processes. Deuteric alteration is a low-temperature magmatic alteration related to the solidification of a melt. The term “deuteric” is restricted to reactions involving changes in primary mineral phases during the process of magmatic crystallization. The agent of deuteric alteration is the volatile material dissolved in the magma which could be either H₂O, CO₂, S, Cl or combinations thereof.

Iddingsite appears as a reddish-brown replacement of Olivine. Iddingsite is a pseudomorph, and during the alteration process the internal structure and/or the chemical composition of the Olivine crystals changes, although the external form is preserved. The chemical formula for Iddingsite has been approximated as MgO*Fe₂O₃*4H₂O where MgO can be substituted by CaO. The alteration of Olivine to Iddingsite occurs in a highly oxidizing environment under low pressure and at intermediate temperatures during the stages of deuteric alteration. Gay, P., and R. W. LeMaitre concluded in ‘Some observations on “Iddingsite”’ (Am. Mineral., 1961, 46, 92-111) that Iddingsite is formed at intermediate temperatures, below those necessary for structural reorganization and above those at which the rock has completely solidified.

The mechanism for the alteration of Olivine to Iddingsite is one of ionic diffusion wherein, under suitable conditions of temperature, pressure and chemical environment, highly mobile hydrogen ions can diffuse into the Olivine structure. By temporarily attaching to the oxygen ions, the highly mobile hydrogen ions are capable of releasing magnesium, ferrous and silicon ions from their sites in the Olivine structure, and allowing their replacement by ferric, aluminum and calcium, etc., ions, provided that suitable concentration gradients exist across the boundary.

The structural changes involved are only slight. For some of the phases recognized, only cation changes are needed; for the others, only slight rearrangement of the essential oxygen framework is necessary. The continuity of the oxygen framework throughout the Iddingsite and the short range order of the cations could undoubtedly account for the optical homogeneity of most of the Iddingsite (Brown, G. and Stephen, I., A structural study of Iddingsite from New South Wales, Australia: Am. Mineral, 1959, 44, 251-260).

It must be emphasized again that this alteration process represents another example of the ability of silicon ions to diffuse fairly readily from their tetrahedral sites in the oxygen framework, and shows that in consideration of transformations in silicate structure, the SiO₄ tetrahedral cannot always be regarded as rigid units of structure (Taylor, H. F. W., 1957, Summarized proceedings of a conference on X-ray analysis, Cardiff, April, 1957: Brit. J. Appl. Phys., 8, 431-432).

The conditions under which the alteration takes place are still a matter for some speculation, except for the pressure which can be assumed to be relatively low (Ming-Shan Sun, The nature of Iddingsite in some basaltic rocks of New Mexico: Am. Mineral., 1957, 42, 525-533.), as Iddingsite is confined to volcanic and hypabyssal rocks. So far as the temperature of formation is concerned, considerable evidence has been accumulated which suggests that the alteration took place in the deuteric stage, before consolidation of the magma (Edwards, A. B., The formation of Iddingsite: Am. Mineral., 1938, 23, 277-281) (Ross, C. S. and Shannon, E. V., 1925, The origin, occurrence, composition and physical properties of the mineral, Iddingsite: Proc. U.S. Nat. Mus., 67, 1-19).

Rims of fresh Olivine mantling Iddingsite which have been observed by Edwards, can also be seen in some of the basaltic rocks from Gough Island and imply that the Iddingsite formed before the Olivine finished crystallizing. However it seems unlikely that a crystal with small domains of “goethite” and “silicate” structures, having a relatively high free energy, would be stable at high temperatures; it would tend to reorganize itself into a more ordered structure. It can only be concluded that “Iddingsite” is formed at intermediate temperatures, below those necessary for structural reorganization, and above those at which the rock has completely solidified.

The chemical environment is undoubtedly one of strong oxidizing conditions, with most of the iron in the ferric state, Fe³⁺, but the suggestion by Edwards (1938) that the magma must differentiate to give an iron-rich liquid cannot be completely valid, for Iddingsite occurs in many non-iron enriched basaltic rocks. The formation of Iddingsite with a high Fe³⁺ content requires only the oxidizing conditions and does not necessarily imply the presence of an iron-rich liquid.

Several attempts had been made to synthesize Iddingsite from Olivine at temperatures in aqueous or acid solutions up to 600° C. and pressure up to 1000 Atm (101.33 MPa) but without success.

However, the only success occurred in synthesizing Iddingsite when CO₂ was utilized in combination with high temperature, high pressure or both. This process requires high energy either in the form of pressure or temperature and also a source of CO₂ which limits the applications to being near CO₂ emissions sources or expensively sourcing CO₂ either in liquefied/pressurized form or burning fuel to generate CO₂.

### DRAWINGS

FIGS. 1 and 2 show microscopic images of Basalt rock.

FIG. 3A shows x-ray diffraction data (XRD) of Basalt rock of FIGS. 1 and 2.

FIG. 3B shows x-ray fluorescence data (XRF) of Basalt rock of FIGS. 1 and 2.

FIG. 4 shows microscopic images of Basalt rock.

### DETAILED DESCRIPTION OF THE INVENTION

The present invention provides a water induced crystallization process (WI-Process) to convert Olivine to Iddingsite in a highly oxidizing environment under low pressure between 50.66-202.65 kPa (0.5-2 atm) and a temperature between about 70° C. and about 200° C. The pressure may be 50.66 kPa, 101.33 kPa, 151.99 kPa or 202.65 kPa (0.5 atm, 1 atm, 1.5 atm or 2 atm). A preferred low pressure is 101.33 kPa (1 atm). A preferred temperature range is 70-120° C., wherein the temperature may be 70° C., 80° C., 90° C., 100° C., 110° C. or 120° C. This process is carried out using well-established industrial technologies and equipment such as ball mills, vertical mills, vibratory mills etc, either in open or closed circuits.

The process parameters include temperature, pressure and the addition of water in the presence of appropriate catalysts to reduce the heat of reaction and produce highly mobile hydrogen ions which diffuse into the Olivine structure. By temporarily attaching to the oxygen ions they are capable of releasing magnesium, ferrous and silicon ions from their sites in the Olivine structure, and allowing their replacement by ferric, aluminum and calcium, etc., ions, provided that suitable concentration gradients exist across the boundary. Appropriate catalysts include oleic acid, amino acids and amino acid derivatives such as triethylamine and triethanolamine. The catalysts can be used either alone or in combination. This process can be enhanced by increasing the surface area of the reaction by grinding the Olivine crystals.

This process is simulating the natural conditions. In which the alteration of Olivine to Iddingsite occurs in a highly oxidizing environment under low pressure and at low temperatures higher than about 70° C. and less than about 200° C.

The conversion of Olivine to Iddingsite is confirmed in several Petrography studies comparing standard volcanic rock containing Olivine, such as Basalt, before and after the WI-activation process which demonstrate that Olivine crystals are converted completely to Iddingsite, by hydration and oxidization of Olivine.

The overall chemical compositions of volcanic rock is not changed before and after WI-process. Whereas, the volcanic rocks crystal shapes is changed in the process and contributes to the formation of Iddingsite complex crystals forms. The presently claimed process helps accelerate the conversion process of Olivine crystals to Iddingsite by WI-process to allow it to take place in very short time frame ranging from seconds to minutes by hydration and oxidizing of Olivine in highly oxidizing environment, whilst in nature this process would take thousands to millions of years.

### EXAMPLES

### Example 1

| | Chemical composition | | | | | | |
|---|---|---|---|---|---|---|---|
| | Cl | MgO | SO₃ | Na₂O | K₂O | SiO₂ | Al₂O₃ |
| % wt. | 0.042 | 8.57 | 0.048 | 3.04 | 0.9 | 44.8 | 13.9 |

| | Chemical composition continued. | | | | | |
|---|---|---|---|---|---|---|
| | Fe₂O₃ | TiO₂ | P₂O₅ | CaO | MnO₂ | LOI |
| % wt. | 13.6 | 2.34 | 0.34 | 11.2 | 0.18 | 0.8 |

A dry Basalt with chemical composition and minerology as shown in report No. 1/2017 was fed to a two compartment ball mill of 5 m Diameter and 15 m length in closed circuit with SEPAX 425 separator at atmospheric pressure and at a rate of 120 ton/hour where the mill is kept under slightly negative relative pressure of 1.47 kPa (the pressure inside the mill 99.86 kPa) will be and mill outlet temperate 100° C.

The water is fed to the mill at a rate to ensure Basalt moisture in the range of 0.5-1.0% wt. and with triethanolamine at rate of 100 g/ton.

Samples are collected after the grinding circuit and the material tested showed similar chemical composition whereas the mineralogy is changed as Olivine is completely converted to Iddingsite.

The results of Example 1 are outlined in Petrography report No. 1/2017.

### Example 2

| | Chemical composition | | | | | | |
|---|---|---|---|---|---|---|---|
| | Cl | MgO | SO₃ | Na₂O | K₂O | SiO₂ | Al₂O₃ |
| % | 0.09 | 8.37 | 1.08 | 3.77 | 1.08 | 46.67 | 15.48 |

| | Chemical composition continued. | | | | | |
|---|---|---|---|---|---|---|
| | Fe₂O₃ | TiO₂ | P₂O₅ | CaO | MnO₂ | LOI |
| % wt. | 11.21 | 1.73 | 0.37 | 9.53 | 0.58 | 11.21 |

A dry Basalt with chemical composition as shown was fed to a two compartment ball mill of 3.6 m Diameter and 9.0 m length in closed circuit with multiple classifier 2×Alpha 1200 separator at atmospheric pressure at a rate of 30 ton/hour were the mill is kept under slightly negative relative pressure of 2.45 kPa (the pressure inside the mill 98.88 kPa) and mill outlet temperate 80° C.

The water is fed to mill at rate to ensure Basalt moisture in range of 0.5-1.0% wt. and with triethanolamine and oleic acid at rate of 60 g/ton and 35 g/ton respectively.

Samples are collected after the grinding circuit and the material tested showed similar chemical composition whereas the mineralogy is changed as Olivine is completely converted to Iddingsite.

The results of Example 2 are outlined in Petrography report No. 7/2019.

Petrography reports No. 1/2017 and 7/2019 were carried out on ministry of national resources and energy—Geological Mapping Division and provide evidence of conversion of Olivine crystals to Iddingsite by WI-Process.

The report's conclusions shows that the following:

### Petrography Reports No. 1/2017

1—The hard rock Basalt studied is natural occurring and consists of primary minerals such as: feldspar, pyroxene (Augite), Olivine (Iddingsite) (natural). These minerals are environmentally friendly green materials and not harmful for human and eco-system. Also the Basalt rock is known to not be affected by water and rust or chemicals.
2—The rock seems to have altered due to processing method (stimulate normal conditions).

The Olivine crystals altered completely to Iddingsite, by hydration and oxidation of the Olivine.

### Rock Name: Basalt—Microscopic Study

Textures: Subophitic, Opbitic, porphyritic, senate.

Primary Minerals:

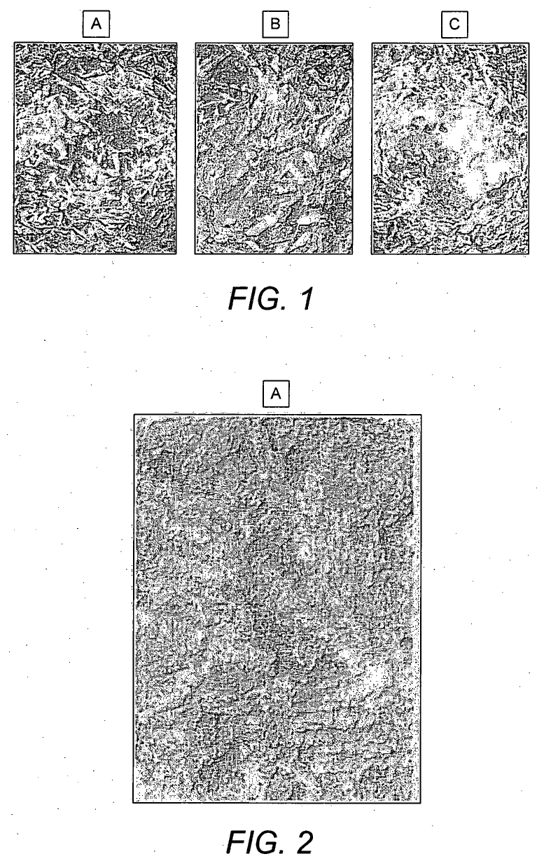

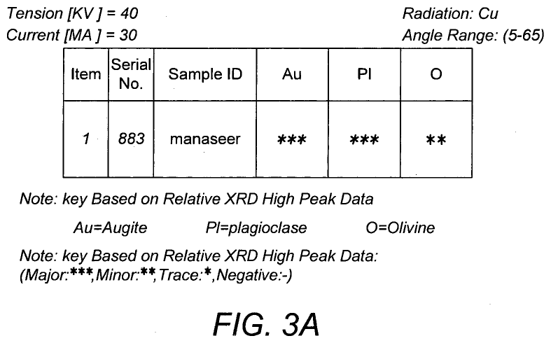

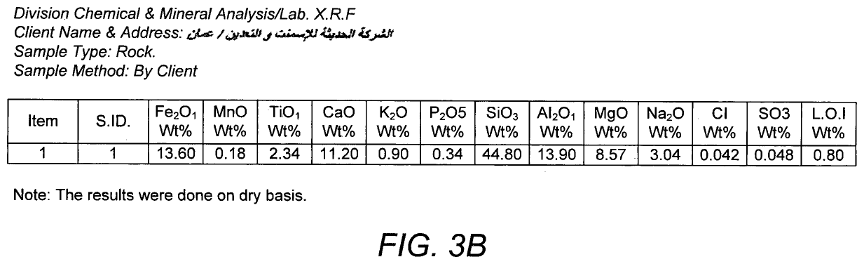

Essentials
1. Feldspar: the main constituent of the sample, which shows laths of plagioclase in different sizes embedded in other crystals to give a subophitict texture (FIGS. 1A & B).
2. Pyroxene: Found and occurs as anhedral to subhedral crystals of augite in different sizes, with second order interference color (FIG. 1B).
3. Olivine (Iddingsite): found as subhedral to sub-rounded from small to large grain size.

shows different shape, completely and partly altered to Iddingsite, which is Iddingsite: formed hydration and oxidation of the Olivine (FIG. 1C).

FIG. 1: (A) Plagioclase laths, XPI, 4×*10× mag; (B) Pyroxene anhedral to subhedral crystals. XPL. 10×*10× mag (C) Olivine altered completely to Iddingsite crystals (shows bloody color), XPL. 4×*10×mag.

Secondary minerals:

Opaques: Occurs as black subhedral to anhedral crystals (FIG. 2A).

FIG. 2A Black opaque crystals, PPL, 4×*10× mag.

### Results and Conclusions:

The hard rock of Basalt was studied is natural occurring, consists of primary minerals such as: feldspar, pyroxene (Augite), Olivine (Iddingsite) (natural). These minerals are environmentally friendly (green materials) and not harmful for human and (eco-system), also the Basalt rock known as not affected by water and rust or chemicals.

The rock seems to have altered due to processing method (stimulate normal conditions). The Olivine crystals altered completely to Iddingsite, by hydration and oxidation of the Olivine.

### Petrography Reports No. 7/2019

1—The samples is friable there is no structures or textures since it is friable, they have Olivine and pyroxene as major contents.
2—The sample is mainly Basalt showed alteration due to weathering process (normal conditions). The Olivine crystals altered completely to Iddingsite by hydration and oxidation of Olivine.

### Rock Name: Basalt—Microscopic Study

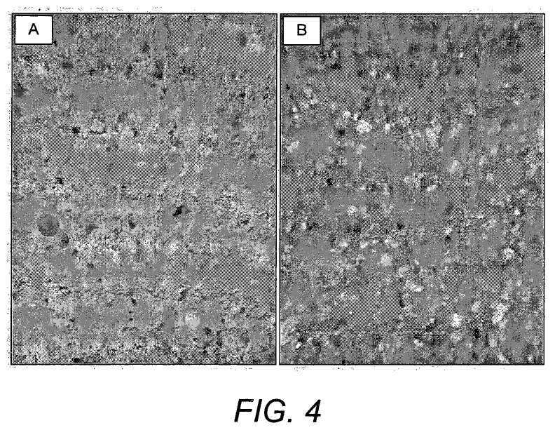

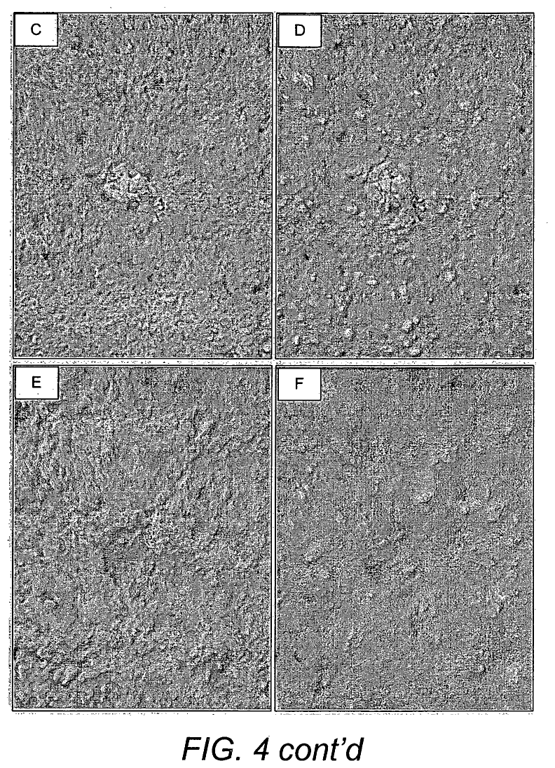

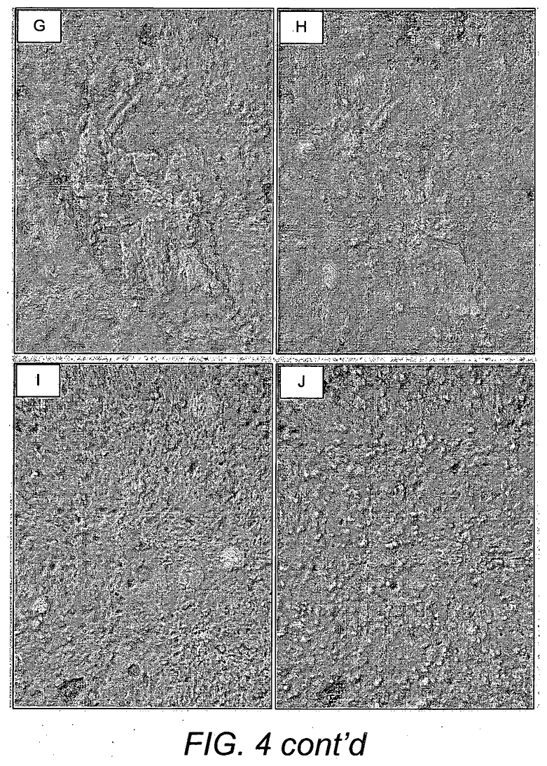

Olivine (Iddingsite): It is found as scattered crystals all around the sample in the small grains, found as subhedral to sub-round crystals (FIG. 4A, PPL, 10×*10× mag & B, XPL, 10×*10× mag.), completely and partly altered to Iddingsite. Iddingsite formed by hydration and oxidation of the Olivine. (FIGS. 4C&E, PPL, 40×*10× mag & D&F, XPL, 40×*10× mag.).

Pyroxene: consist mainly of augite crystals showing uniform yellowish interference color (FIG. 4G, PPL, 40×*10× mag & H, XPL, 40×*10× mag.).

Basalt rock fragment: consist of Olivine, pyroxene and ground mass made up of plagioclase laths (FIG. 4I, PPL, 10×*10× mag & 1, XPL, 10×*10× mag.).

Opaques: found as small dark euhedral crystals of iron oxides (FIG. 4I, PPL, 10×*10× mag & J, XPL, 10×*10× mag.).

### Result and Conclusions

The sample is friable there is no structures or textures since it is friable. They have Olivine and pyroxene as major contents.

The sample is mainly Basalt showed alteration due to weathering processes (normal conditions). The Olivine crystals altered completely to Iddingsite by hydration and oxidation of the Olivine.

1. A water induced crystallization process of converting Olivine crystals to Iddingsite crystals, wherein the crystallization process is carried out at a temperature between about 70° C. and about 200° C. and comprises at least one catalyst wherein the catalyst is selected from oleic acid, an amino acid or an amino acid derivative or any combination thereof.

2. A water induced crystallization process according to claim 1, wherein the process is carried out at a pressure between about 0.5 atm and about 2 atm.

3. A water induced crystallization process according to claim 2, wherein the process is carried out at a pressure of about 0.5 atm, about 1 atm, about 1.5 atm or about 2 atm.

4. A water induced crystallization process according to claim 2, wherein the pressure is about 1 atm.

5. A water induced crystallization process claim 1, wherein the process is carried out at a temperature between about 70° C. and about 120° C.

6. A water induced crystallization process according to claim 5, wherein the temperature is about 70° C., about 80° C., about 90° C., about 100° C., about 110° C. or about 120° C.

7. A water induced crystallization process according to claim 1, wherein the catalyst is triethylamine, triethanolamine, oleic acid, or a combination thereof.
